(19) United States
(12) Patent Application Publication
(10) Pub. No.: US 2021/0026344 A1
(43) Pub. Date: Jan. 28, 2021

(54) VEHICLE EQUIPMENT CONTROL DEVICE, A METHOD OF CONTROLLING VEHICLE EQUIPMENT, AND NON-TRANSITORY STORAGE MEDIUM STORING A PROGRAM FOR CONTROLLING VEHICLE EQUIPMENT

(71) Applicant: TOYOTA JIDOSHA KABUSHIKI KAISHA, Toyota-shi (JP)

(72) Inventors: Takashi YASUDA, Tokyo-to (JP); Yoshinori KAKIYA, Chofu-shi (JP); Masakazu HATTORI, Kawasaki-shi (JP)

(73) Assignee: TOYOTA JIDOSHA KABUSHIKI KAISHA, Toyota-shi (JP)

(21) Appl. No.: 16/887,854

(22) Filed: May 29, 2020

(30) Foreign Application Priority Data
Jul. 23, 2019 (JP) 2019-135361

(51) Int. Cl. G05D 1/00

(52) U.S. Cl. CPC G05D 1/0016; B62D 15/0285

(57) ABSTRACT

An vehicle equipment control device includes a memory and a processor. The processor determines whether a state of a vehicle will transition to another state, the vehicle being equipped with an vehicle equipment having a function including providing a service to a user, in a case in which the state of the vehicle will transition, acquires at least one of a communication amount or a calculation amount which will be required by the vehicle equipment after the state of the vehicle has transitioned to another state. The in-vehicle equipment control device is configured to determine whether to change the parameters of the vehicle equipment based at least partially on the state of the battery of the vehicle such that at least one of the acquired communication amount or the acquired calculation amount.

### CROSS-REFERENCE TO RELATED APPLICATION

This application is based on and claims priority under 35 USC 119 from Japanese Patent Application No. 2019-135361 filed on Jul. 23, 2019, the disclosure of which is incorporated by reference herein.

### BACKGROUND

### Technical Field

The present disclosure relates to a vehicle equipment control device, a method of controlling a vehicle equipment, and a non-transitory storage medium that stores a program for controlling a vehicle equipment.

### Related Art

For example, Japanese Patent Application Laid-Open No. 2014-088150 discloses a technique for monitoring the state of a battery mounted on a vehicle in a vehicle-mounted network including a central gateway and a plurality of ECUs (that is, Electronic Control Units). Further, it is disclosed that control such as forcibly shifting the ECU to a sleep state when the remaining battery power becomes low is performed.

Examples of vehicle equipment that consume battery power in vehicles include lighting devices such as headlights, tail lights, and interior lights. These lighting devices are indispensable to movement by vehicle. In addition, electronic devices such as air conditioners, audio, and displays are installed in most vehicles. These electronic devices are for ensuring comfort in the vehicle while moving.

In addition, in recent years, vehicles equipped with ADAS, that is, an Advanced Driver Assistance System, have been increasing in order to prevent and reduce accidents. In vehicles equipped with the ADAS, the number of sensors, such as cameras mounted on the vehicle, is increasing and the definition thereof is increasing.

Recently, a vehicle called a Connected car that can be connected to the Internet has appeared. In a Connected car, a communication device is installed to connect to a mobile phone network, WiFi, or the like.

Further, in the near future, it is expected that vehicles corresponding to ADS, that is, a vehicle corresponding to the Autonomous Driving System automatic driving system, and vehicles corresponding to vehicles as MaaS, that is, a vehicle as a means of providing mobility as a service, will appear. In ADS-compatible vehicles, further increase in the number of sensors such as cameras mounted on the vehicles and higher definition are expected. In addition, it is necessary to install an in-vehicle computer that performs advanced calculations. In a MaaS-compatible vehicle, new electronic devices, such as medical equipment, cooking equipment, and a large monitor, which are not provided in conventional vehicles, are additionally expected to be installed in order to provide services such as logistics, medical care, eating and drinking, and space.

Therefore, as shown in FIG. 16, the power consumption of vehicle equipment is expected to increase further in the future with the increase of vehicle equipment and the diversification of the services provided by the vehicle equipment to the user.

On the other hand, for example, it is conceivable to apply the technology disclosed in Japanese Patent Application Laid-Open No. 2014-088150 to a vehicle equipped with a vehicle equipment having a function of providing a service to a user as described above. In this case, there are concerns that when the remaining battery level becomes low, control for stopping the provision of services such as forcibly shifting the ECU to the sleep state would be performed, so that desired services cannot be received or comfort in the vehicle is impaired.

### SUMMARY

The present disclosure provides a vehicle equipment control device that enables the service provision time of vehicle equipment to be extended.

A vehicle equipment control device according to a first aspect includes an acquisition unit and a determination unit. The acquisition unit determines whether a state of a vehicle will transition to another state, the vehicle being equipped with a vehicle equipment having a function including providing a service to a user, in a case in which the state of the vehicle will transition, acquires at least one of a communication amount or a calculation amount which will be required by the vehicle equipment after the state of the vehicle has transitioned to another state. The determination unit determines whether to change a parameter of the vehicle equipment based at least partially on a state of a battery of the vehicle so as to realize at least one of the communication amount or the calculation amount acquired by the acquisition unit.

In the first aspect, the acquisition unit determines whether the state of the vehicle will transition to another state, it is determined whether or not to change the parameter of the vehicle equipment so as to realize at least one of the communication amount or the calculation amount required for the vehicle equipment after the state of the vehicle has transitioned, based at least partially on the state of the battery of the vehicle. Accordingly, in a case in which it is determined that the parameter of the vehicle equipment will be changed, by changing the parameter of the vehicle equipment, at least one of the communication amount or the calculation amount required for the vehicle equipment after the vehicle state has transitioned, will be realized at the vehicle equipment. Therefore, the operation of the vehicle equipment is adjusted in accordance with the state of the vehicle after the transition. Further, in a case in which it is determined that the parameter of the vehicle equipment will not be changed, the parameter of the vehicle equipment is not changed, whereby the vehicle equipment continues to operate in accordance with the state of the vehicle before the transition.

As described above, in the first aspect, the operation of the vehicle equipment is selectively adjusted based at least partially on the state of the battery of the vehicle. As a result, it is possible to make the service provision time by the vehicle equipment longer than in a case in which the control for stopping the provision of the service is performed when the remaining battery power level becomes low.

According to a second aspect, in the first aspect, it is determined that the state of the vehicle will transition to another state in a case in which at least one of a traveling state of the vehicle or a service provided by the vehicle equipment has changed.

A change in the traveling state of the vehicle or a change in the service provided by the vehicle equipment both lead to a change in the amount of battery discharge. According to the second aspect, the occurrence of an event that will lead to a change in the amount of battery discharge can be determined to be a transition in the state of the vehicle.

According to a third aspect, the first aspect further includes a storage unit. The storage unit stores first information that defines at least one of a communication amount or a calculation amount for each respective traveling state of the vehicle, and second information that defines at least one of a communication amount or a calculation amount for each respective service provided by the vehicle equipment. The acquisition unit is configured to acquire at least one of the required communication amount or the required calculation amount by multiplying first information, that corresponds to a traveling state after transition of the state of the vehicle, and second information, that corresponds to a service provided after transition of the state of the vehicle.

In the third aspect, acquiring at least one of the communication amount or the calculation amount required for the vehicle equipment after the state of the vehicle has transitioned, can be realized by a simple process of multiplying the first information and the second information.

According to a fourth aspect, in the first aspect, the determination unit performs a further determination. The determination unit determines whether or not to change the parameter of the vehicle equipment based on the battery state of the vehicle, a traveling state of the vehicle, and whether or not it is predicted that power consumption of the vehicle equipment will decrease due to changing the parameter of the vehicle equipment.

According to the fourth aspect, the determination as to whether or not to change the parameter of the vehicle equipment can be performed more appropriately in consideration of safety and of trends in changes in the remaining battery level accompanying changes to the parameters of the vehicle equipment.

According to a fifth aspect, in the first aspect, the determination unit determines not to change the parameter of the vehicle equipment in a case in which a first determination, as to whether or not the battery state is a state of discharge, is negative and a second determination, as to whether or not the vehicle is traveling, is affirmative.

In the fifth aspect, in a case in which the battery state is not a state of discharge and the vehicle is traveling, it is possible to prioritize safety by determining that the parameter of the vehicle equipment will not be changed.

According to a sixth aspect, in the first aspect, the determination unit determines to change the parameter of the vehicle equipment in a case in which a first determination, as to whether or not the battery state is a state of discharge, is negative and a second determination, as to whether or not the vehicle is traveling, is negative.

According to the sixth aspect, it is possible to safely perform a change to the parameter of the vehicle equipment by determining to change the parameter of the vehicle equipment in a case in which the state of the battery is not a state of discharge and the vehicle is not traveling.

According to a seventh aspect, in the first aspect, the determination unit performs a further determination. The determination unit determines to change the parameter of the vehicle equipment in a case in which a first determination, as to whether or not the battery state is a state of discharge, is affirmative and a third determination, as to whether or not it is predicted that power consumption of the vehicle equipment will decrease due to the changing the parameter of the vehicle equipment, is affirmative.

In the seventh aspect, it is possible to suppress the battery discharge amount by determining to change the parameter of the vehicle equipment in a case in which the state of the battery is a state of discharge and it is predicted that power consumption of the vehicle equipment will decrease in conjunction with the change the parameter of the vehicle equipment.

According to an eighth aspect, in the first aspect, the determination unit performs a further determination. The determination unit determines not to change the parameter of the vehicle equipment in a case in which a first determination, as to whether or not the battery state is a state of discharge, is affirmative, a third determination, as to whether or not it is predicted that power consumption of the vehicle equipment will decrease due to the changing the parameter of the vehicle equipment, is negative, and a fourth determination, as to whether or not a remaining amount of the battery is equal to or higher than a predetermined value, is negative.

In the eighth aspect, it is determined that the parameter of the vehicle equipment will not be changed in a case in which the state of the battery is a state of discharge, it is predicted that power consumption of the vehicle equipment will not decrease in conjunction with the change to the parameter of the vehicle equipment, and remaining amount of the battery is not equal to or higher than a predetermined value. As a result, it is possible to avoid an increase in the amount of battery discharge.

According to a ninth aspect, in the first aspect, the determination unit performs a further determination. The determination unit determines to change the parameter of the vehicle equipment in a case in which a first determination, as to whether or not the battery state is a state of discharge, is affirmative, a third determination, as to whether or not it is predicted that power consumption of the vehicle equipment will decrease due to changing the parameter of the vehicle equipment, is negative, and a fourth determination, as to whether or not a remaining amount of the battery is equal to or higher than a predetermined value, is affirmative.

In the ninth aspect, it is determined that the parameter of the vehicle equipment will be changed in a case in which the state of the battery is a state of discharge, it is predicted that power consumption of the vehicle equipment will not decrease due to changing the parameter of the vehicle equipment, and remaining amount of the battery is equal to or higher than a predetermined value. As a result, the parameter of the vehicle equipment can be changed while allowing an increase in the battery discharge amount.

According to a tenth aspect, in the fifth aspect, the determination unit performs a further determination. The determination unit determines not to change the parameter of the vehicle equipment in a case in which the first determination is affirmative, a fifth determination, as to whether or not the vehicle is moving, is affirmative, and a sixth determination, as to whether or not a time required for the change to the parameter of the vehicle equipment is less than a predetermined time, is negative.

In the tenth aspect, it is determined that the parameter of the vehicle equipment will not be changed in a case in which the state of the battery is a state of discharge, the vehicle is moving, and the time required for the change to the parameter of the vehicle equipment is not less than the predetermined time. As a result, in circumstances in which it becomes necessary to start moving the vehicle, for example, it is possible to avoid a state in which the change to the parameter of the vehicle equipment is not completed; that is, a state in which the environment in which a service is normally provided has not been established.

The present disclosure has the effect that it is possible to lengthen the time of service provision by a vehicle equipment.

### BRIEF DESCRIPTION OF THE DRAWINGS

Exemplary embodiments of the present invention will be described in detail based on the following figures, wherein:

FIG. 1 is a block diagram showing a schematic configuration of an on-board system;

FIG. 2 is a flowchart illustrating an example of an in-vehicle system management process performed on a controller of a central ECU;

FIG. 3 is a conceptual diagram illustrating an example of the definition of the state of a vehicle;

FIG. 4 is a table showing an example of settings relating to the amount of communication and calculation for each state belonging to the “running state”, that is, an example of running state information;

FIG. 5 is a table showing an example of the settings regarding the amount of communication and calculation for each service belonging to the “operating service”, that is, an example of the operating service information;

FIG. 6 is an image diagram for explaining the process of estimating the communication amount/computation amount required in the vehicle state after a transition by multiplying the communication amount/computation amount required in the “running state” and the communication amount/computation amount required in the “operation service”;

FIG. 7 is an image diagram for explaining a process of calculating the settings of the wireless communication unit, the switch/communication control unit, and the CPU from the communication amount/computation amount required in the vehicle state after the transition, to obtain power consumption;

FIG. 8 is an image diagram for explaining a setting change instruction to the wireless communication control unit, the switch/communication control unit, and the CPU;

FIG. 9 is a flowchart showing an example of a process for determining a change to a request value;

FIG. 10 is a chart showing the action and effect of each route of the condition branches of the process of determining the change to the required value;

FIG. 11 is an image diagram showing a processing flow when a new service is turned on while the vehicle is running in the change determination processing of the request value;

FIG. 12 is a flowchart showing another example of the change determination processing of the request value;

FIG. 13 is a chart showing an example of a table for determining the time required for changing the parameter settings of the in-vehicle system;

FIG. 14 is a conceptual diagram showing another example of the definition of the driving state;

FIGS. 15A and 15B are image diagrams showing other examples of setting the link speed for each communication link of the vehicle-mounted system; and

FIG. 16 is a diagram showing a tendency of power consumption in the vehicle.

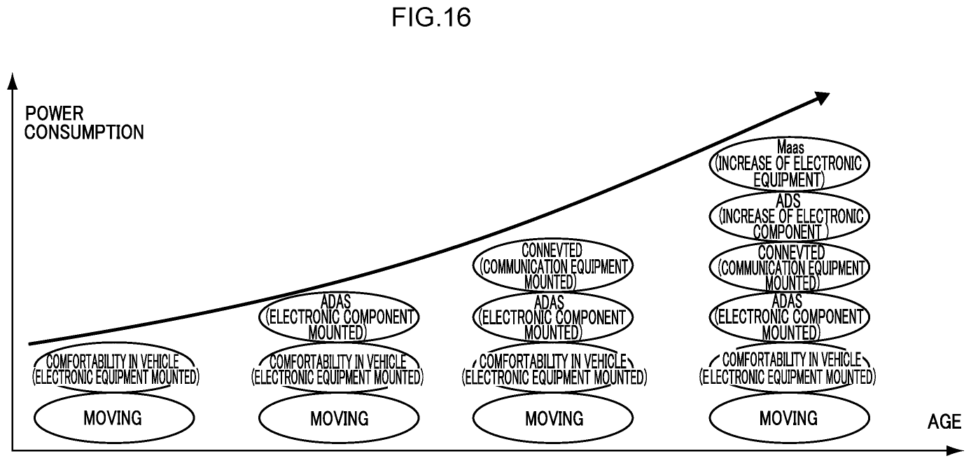

### DETAILED DESCRIPTION

Hereinafter, an example of an embodiment of the present disclosure will be described in detail with reference to the drawings.

### First Exemplary Embodiment

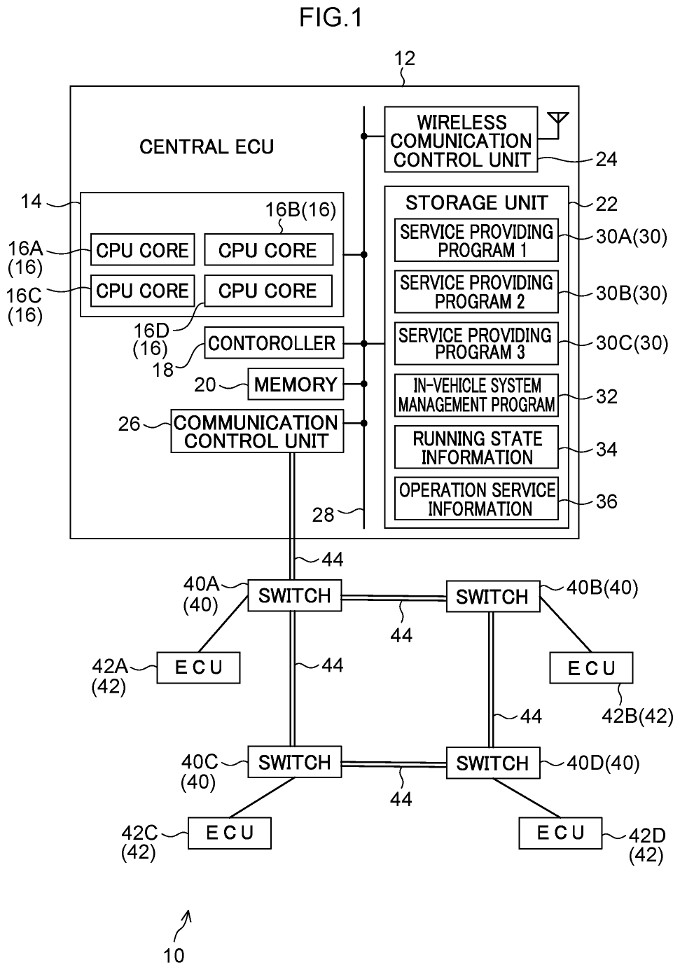

FIG. 1 shows an in-vehicle system 10 according to the embodiment. The in-vehicle system 10 is an example of a vehicle equipment. The in-vehicle system 10 includes a central ECU 12. The central ECU 12 is provided in the in-vehicle system 10 as an in-vehicle computer that performs advanced arithmetic processing in order to support a Connected car, an ADS, a MaaS, and the like.

Specifically, the central ECU 12 includes a CPU on which a plurality of CPU cores 16A, 16B, 16C, 16D are mounted; that is, a Central Processing Unit 14, and a controller 18 with a built-in CPU. Further, the central ECU 12 includes a memory 20, such as a ROM, that is, a Read Only Memory or a RAM, that is, a Random Access Memory, and a nonvolatile storage unit 22, such as an HDD, that is, a Hard Disk Drive or an SSD, that is, a Solid State Drive. Further, central ECU 12 includes a wireless communication control unit 24 and a communication control unit 26. The CPU 14, the controller 18, the memory 20, the storage unit 22, the wireless communication control unit 24, and the communication control unit 26 are communicably connected to each other via an internal bus 28.

The storage unit 22 stores each of a plurality of service providing programs 30A to 30C for providing services such as a Connected car, ADS, and MaaS, an in-vehicle system management program 32, traveling state information 34, and operation service information 36. The service providing programs 30A to 30C are executed by the CPU 14, and the in-vehicle system management program 32 is executed by the controller 18. Although FIG. 1 shows a configuration in which three service providing programs 30 are stored in the storage unit 22, the number of service providing programs 30 stored in the storage unit 22 is not limited to three. The central ECU 12 is an example of a vehicle-mounted device control device, the storage unit 22 is an example of a memory, and the controller 18 functions as an example of a processor, an acquisition unit, and a determination unit.

The CPU 14 can change how many of the CPU cores 16 mounted on the CPU 14 are operated. The setting of the number of CPU cores 16 to be operated is changed by the controller 18 in accordance with the state of the vehicle, such as the execution state of the service providing program 30 such as Connected car, ADS, or MaaS. The CPU 14 can also change the operating frequency of the CPU core 16. The setting of the operating frequency of the CPU core 16 is changed by the controller 18 according to the state of the vehicle, such as the execution state of the service providing program 30. In this way, the control of changing the number of operating CPU cores and the operating frequency in accordance with the application operation status has been put to practical use in server devices in data centers and in smartphones, for example.

Although FIG. 1 shows a configuration in which four CPU cores 16A to 16D are mounted on the CPU 14, the number of CPU cores 16 mounted on the CPU 14 is not limited to four. The central ECU 12 may have a multiprocessor configuration in which a plurality of CPUs, each having one or more CPU cores, are provided.

The wireless communication control unit 24 transmits and receives data to and from a data center outside the vehicle by wireless communication in order to provide services such as Connected car, ADS, and MaaS. An infrastructure commonly used for constant connection while moving is the mobile phone network. The wireless communication control unit 24 selects and uses a wireless communication method (hereinafter, referred to as an out-of-vehicle communication method) from among a plurality of communication standards, such as 3G (third generation), 4G (fourth generation), and 5G (fifth generation). The setting of the external communication system of the wireless communication control unit 24 is changed by the controller 18 in accordance with the state of the vehicle, such as the execution state of the service providing program 30 such as Connected car, ADS, and MaaS.

The in-vehicle system 10 includes a plurality of switches 40A, 40B, 40C, and 40D. Further, the in-vehicle system 10 includes an ECU 42A connected to the switch 40A, an ECU 42B connected to the switch 40B, an ECU 42C connected to the switch 40C, and an ECU 42D connected to the switch 40D. The switches 40A to 40D and the switch 40A and the communication control unit 26 of the central ECU 12 are connected via the Ethernet, that is, an Ethernet communication line 44, which is a registered trademark.

The switches 40A to 40D relay data communication between the central ECU 12 and each of the ECUs 42A to 42D. Switches have conventionally been used for high-speed, large-capacity Ethernet communication, and are often used in buildings such as offices and schools. Recently, they have also been used in in-vehicle networks.

The Ethernet communication has a plurality of link speeds, that is, a communication speed of data transmitted through the Ethernet communication line 44, and 100 Mbps (megabit/second), 1 Gbps (gigabit/second), and 2.5 Gbps, 5 Gbps, etc. are standardized. The switches 40A to 40D and the communication control unit 26 can change the link speed. That is, the link speed in the Ethernet communication between the switches 40A to 40D and between the switch 40A and the central ECU 12 can be changed only by changing the setting while keeping the same Ethernet communication line 44. A switch corresponding to a plurality of link speeds has been put to practical use for Ethernet communication in offices and schools, for example. The setting of the link speed in the Ethernet communication between the switches 40A to 40D and between the switch 40A and the central ECU 12 is changed by the controller 18 of the central ECU 12. The setting of these link speeds is changed in accordance with the state of the vehicle, such as the execution status of the service providing program 30 such as Connected car, ADS, or MaaS.

The ECUs 42A to 42D are ECUs that manage or control various parts of the vehicle. The ECUs 42A to 42D include an ECU that manages the battery of the vehicle.

Although FIG. 1 shows a configuration in which four switches 40 and four ECUs 42 are provided, the number of the switches 40 and the ECU 42 is not limited to four. Communication between the switches 40A to 40D and between the switch 40A and the central ECU 12 may be communication conforming to a communication standard other than Ethernet communication.

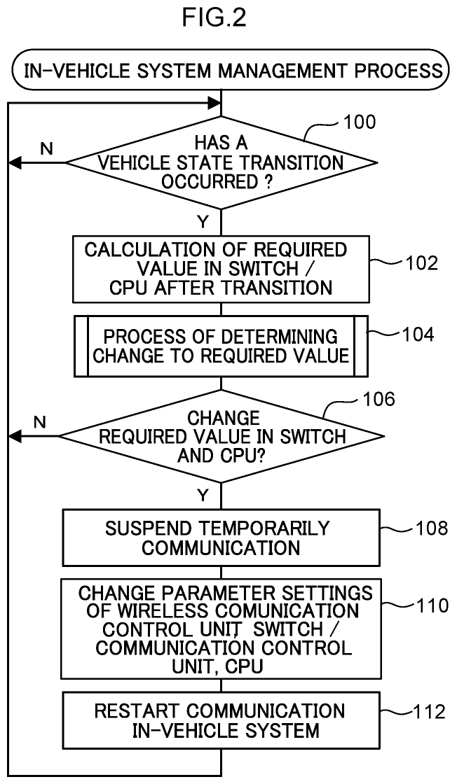

Next, the operation of the first embodiment will be described with reference to FIG. 2. FIG. 2 shows how the controller 18 changes the settings for each of the outside communication system of the wireless communication control unit 24, the link speed of the switch 40/communication control unit 26, the number of operating CPU cores of the CPU 14, and the operating frequency of the CPU core 16. Note that the in-vehicle system management process illustrated in FIG. 2 is realized by the controller 18 executing the in-vehicle system management program 32.

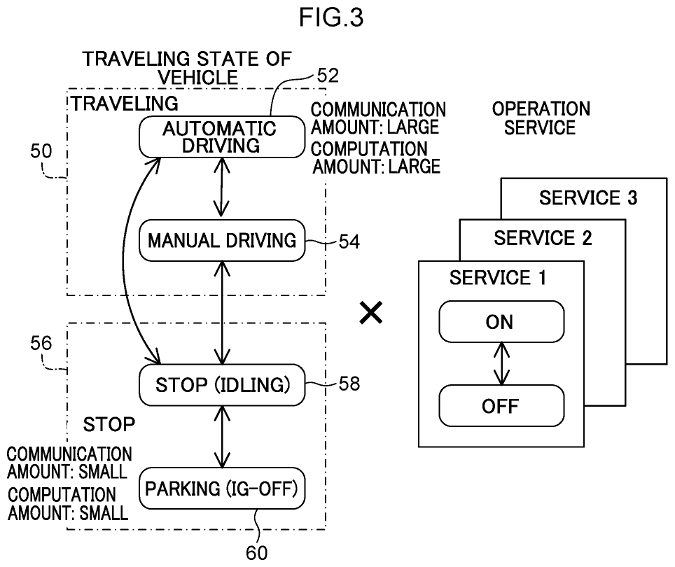

In step 100 of the in-vehicle system management process, the controller 18 determines whether or not a vehicle state transition has occurred. FIG. 3 shows an example of the definition of the vehicle state in the present embodiment. The vehicle state is defined so that the required communication amount, that is, the data amount, and the required calculation amount associated with communications and services, that is, the CPU processing amount, are different in each state, and is defined as a multiplication of the “running state” and the “operation service” shown in FIG. 3.

First, the “running state” is a state of vehicle travel in which the vehicle can only adopt one such state, and is roughly classified into two states: “traveling 50” and “stopped 56”. “Running 50” is a state in which the vehicle is moving at a speed equal to or higher than a certain value, and both of the communication amount and the calculation amount are large. The “running 50” is divided into two states: “automatic driving 52” and “manual driving 54”, that is, non-automatic driving. The “automatic operation 52” is a state where the communication amount and the calculation amount are particularly large, and the “manual operation 54” is a state where the communication amount and the calculation amount are relatively small.

“Stop 56” is a state where the vehicle is stopped, but “Stop 56” is also divided into two states: “Stop 58” and “Parking 60”. “Stop 58” is a state in which the engine is running so that traveling can be resumed at any time, and a certain amount of communication and computation is required. “Parking 60” is a state in which the ignition of the vehicle is turned off, and the required communication amount and calculation amount are both minimal.

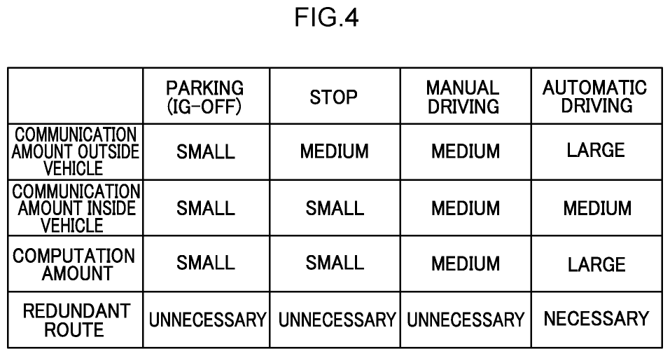

FIG. 4 shows information summarizing the settings related to the communication amount and the calculation amount for each state included in the “running state”; that is, the running state information 34. See also FIG. 1. In the traveling state information illustrated in FIG. 4, “redundant path” indicates whether or not to provide a plurality of communication paths for transmitting and receiving data in preparation for a communication failure in the in-vehicle system 10. When the “redundant path” is “unnecessary”, the link speed can be set to zero at any one location of the Ethernet communication line 44, which leads to power saving. The traveling state information is an example of first information.

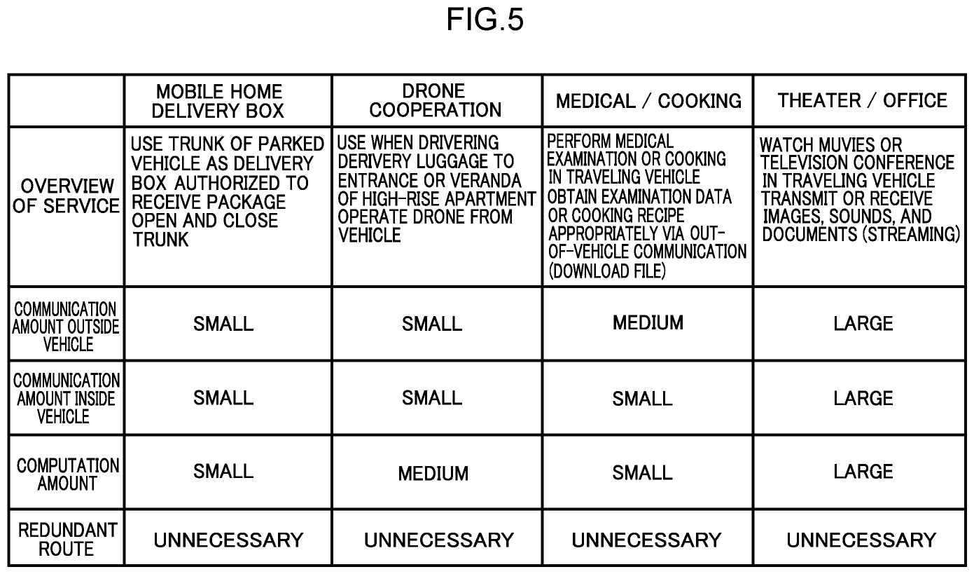

On the other hand, the “operating service” can be turned on/off independently for each service. Since operability in which running state differs depending on the service, the communication amount and the calculation amount differ depending on the service. Information that summarizes the settings related to the communication amount and the calculation amount for each individual service that can be considered for a MaaS-compatible vehicle. That is, the operation service information 36 is shown in FIG. 5. See also FIG. 1. The operation service information 36 is an example of second information. Note that, in FIG. 5, “Mobile home delivery box”, “Drone cooperation”, “Medical/Cooking”, and “Theater/office” are listed as the services that can be considered for the MaaS-compatible vehicle, but the services are not limited to these.

In step 100, when at least one of the “running state” and the “operation service” has changed, it is determined that a vehicle state transition has occurred. If the determination in step 100 is negative, step 100 is repeated until the determination in step 100 is affirmative.

When a transition of the vehicle state occurs, the determination in step 100 is affirmative, and the process proceeds to step 102. In step 102, the controller 18 calculates settings of the wireless communication control unit 24, the switch 40/communication control unit 26, and the CPU 14 (setting of parameters of the vehicle-mounted system 10) required in the vehicle state after the transition.

Specifically, the communication amount/computation amount required in the “running state” after the transition is predicted from the traveling state information 34 shown in FIG. 4, and the communication amount/computation amount required in the “operation service” after the transition is predicted from the operating service information 36 shown in FIG. 5. Further, by multiplying the predicted communication amount and calculation amount, the communication amount and calculation amount required in the vehicle state after the transition are estimated.

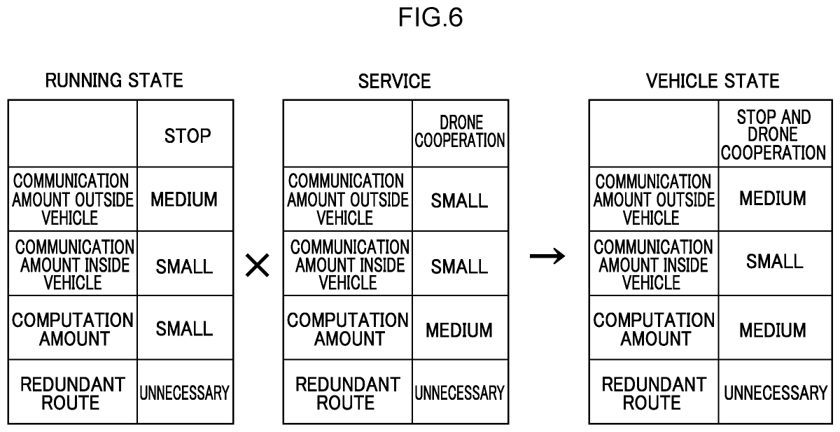

As an example, FIG. 6 shows an example of the communication amount and the calculation amount required when the vehicle state after the transition is “stop 58” and “drone cooperation”. In this example, the communication amount outside the vehicle, the communication amount inside the vehicle, and the calculation amount are each adjusted to the maximum values from the “running state” and, in some cases, from a plurality of “operation services”. Regarding the redundant route, if nothing is set as “necessary”, it is “unnecessary”; otherwise, it is “necessary”.

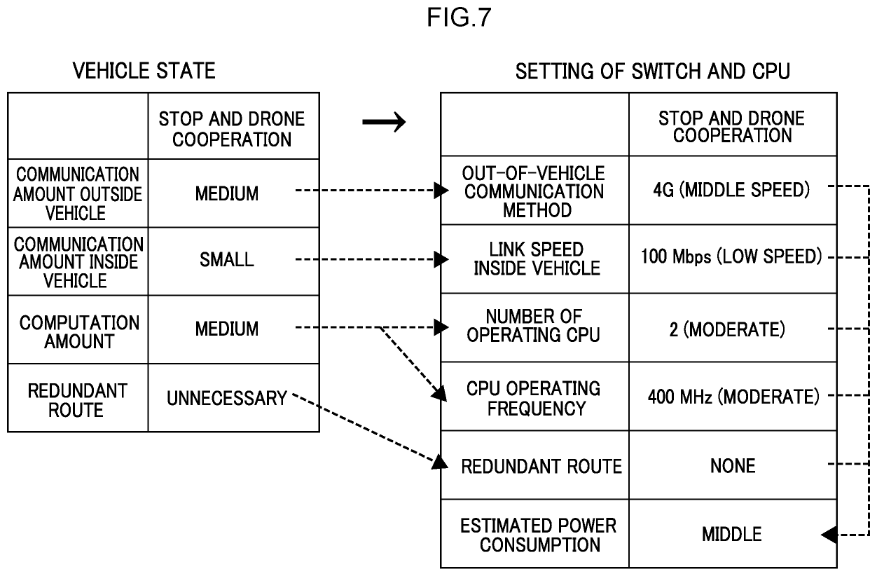

Next, parameter settings of the wireless communication control unit 24, the switch 40/communication control unit 26, and the CPU 14 required in the vehicle state after the transition are calculated from the communication amount and the computation amount required in the vehicle state after the transition. Here, the settings of the parameters are “external communication method”, “in-vehicle link speed”, “number of operating CPUs”, “CPU operating frequency”, and “redundant path”. The power consumption when the settings are changed to the calculated settings—that is, an estimated value—is obtained. As an example, FIG. 7 illustrates an example of calculating the settings of the parameters of the wireless communication control unit 24, the switch 40/communication control unit 26, and the CPU 14 required when the vehicle state after the transition is “stop 58” and “drone cooperation”, and calculating the power consumption (estimated value). Note that the broken lines in FIG. 7 indicate what information each parameter of the wireless communication control unit 24, the switch 40/communication control unit 26, and the CPU 14 depends on for setting.

In this way, in this embodiment, the settings of the parameters of the wireless communication control unit 24, the switch 40/communication control unit 26, and the CPU 14 necessary for each vehicle state are calculated such that the power consumption is minimized as far as possible in each state. Step 102 described above is an example of an acquisition process of the controller 18 serving as a processor or an acquisition unit.

In step 104, the controller 18 performs a process of determining a change to the required value. In the change determination process for the request value, it is determined whether the parameters of the in-vehicle system 10—that is, the parameter settings of the wireless communication control unit 24, the switch 40/communication control unit 26, and the CPU 14—will be changed or the parameter settings will be maintained without being changed, and details are described below. Step 104 is an example of a determination process performed by the controller 18 serving as a processor or a determination unit.

In step 106, the controller 18 determines whether or not it has been determined, in the change determination processing for the required value in step 104, that the parameter settings of the wireless communication control unit 24, the switch 40/communication control unit 26, and the CPU 14 are to be changed. If the result of the determination in step 106 is negative, the process returns to step 100. In this case, the parameter settings of the wireless communication control unit 24, the switch 40/communication control unit 26, and the CPU 14 are maintained without being changed.

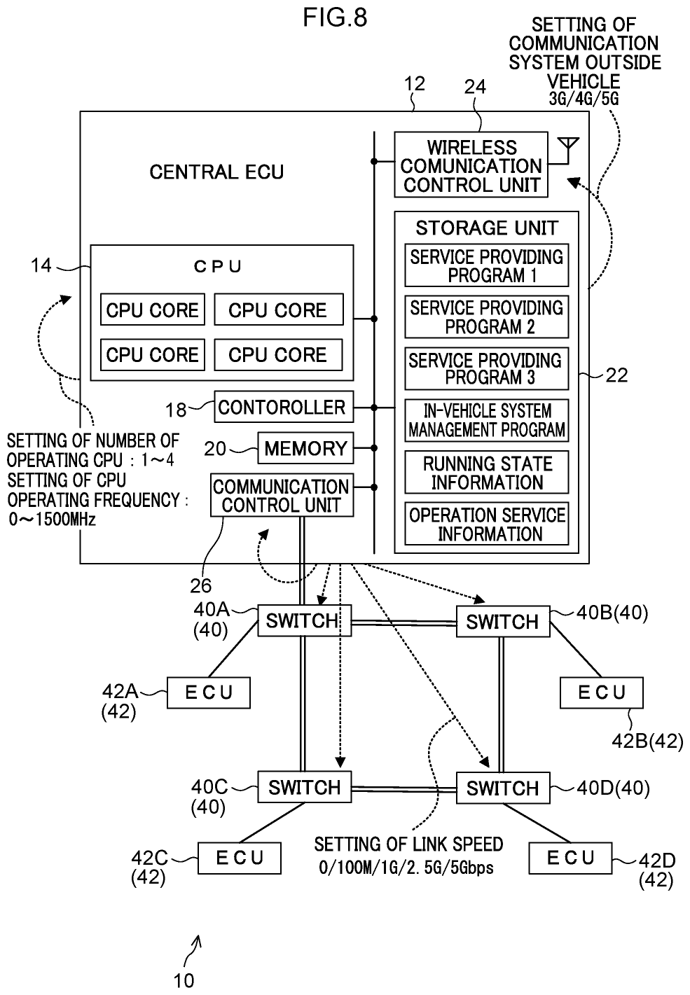

On the other hand, if the determination in step 106 is affirmative, the process proceeds to step 108, and in step 108, the controller 18 temporarily suspends communication in the in-vehicle system 10 and communication outside the vehicle. In the next step 110, the controller 18 instructs the wireless communication control unit 24, the switch 40/communication control unit 26, and the CPU 14 to change the parameter settings, as shown in FIG. 8 as an example. As a result, at least one setting of the parameters of “external communication method”, “in-vehicle link speed”, “number of operating CPUs”, “CPU operating frequency”, and “redundant path”, is changed. When the setting change is completed, in the next step 112, the controller 18 restarts communication in the in-vehicle system 10 and communication outside the vehicle.

The reason why the communication is temporarily stopped in step 108 is that it is generally impossible to change the set value of a communication device while continuing communication. However, the controller 18 can notify the ECUs 42A to 42D of the start and end timings of the temporary stopping of the communication. Thus, the ECU 42 that performs data transmission can store communication data while communication is temporarily stopped, and can collectively transmit the stored communication data when the communication is restarted. In the case of a communication service that can tolerate communication time delay and jitter—that is, fluctuations in communication time—the service can be prevented from being stopped by storing data while the communication is temporarily stopped.

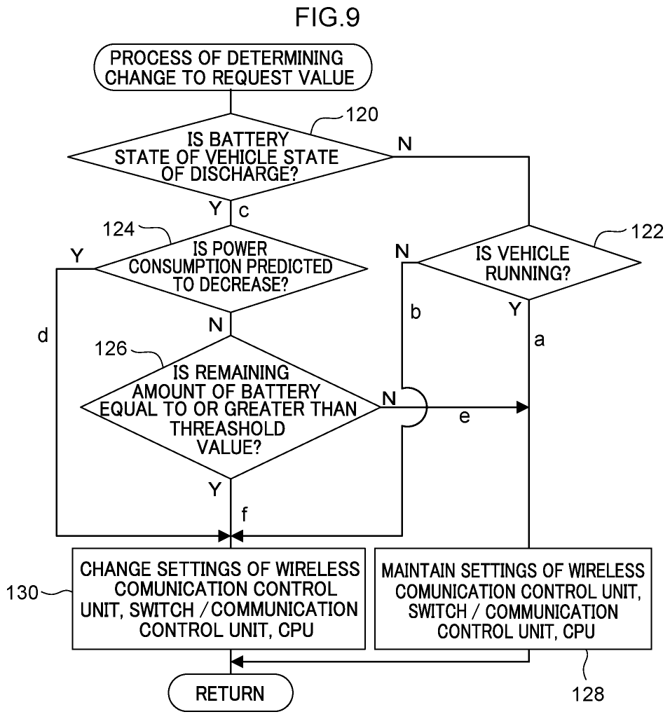

Next, with reference to FIG. 9, a process of determining a change to a request value will be described. In step 120 of the change determination process for the required value, the controller 18 determines whether the battery state of the vehicle is a state of discharge. If the determination in step 120 is negative, the vehicle is running at a predetermined speed or higher, or the battery is being charged at a house or a stand, for example. Step 120 is an example of a first determination.

If the determination in step 120 is negative, the process proceeds to step 122, and in step 122, the controller 18 determines whether the vehicle is running. Step 122 is an example of a second determination. If the result of the determination in step 122 is affirmative, the process proceeds to step 128. In step 128, the controller 18 outputs parameter setting maintenance of the in-vehicle system 10—that is, the wireless communication control unit 24, the switch 40/communication control unit 26, and the CPU 14—and ends the change determination process for the required value.

In this way, when the battery state is not a state of discharge and the vehicle is running, it is determined that the parameter settings of the in-vehicle system 10 are not to be changed. Therefore, reduced safety accompanying changes in the parameter settings of the in-vehicle system 10 can be avoided.

Further, if the determination in step 122 is negative, the process proceeds to step 130. In step 130, the controller 18 outputs the implementation of the parameter setting changes of the in-vehicle system 10—that is, the wireless communication control unit 24, the switch 40/communication control unit 26, and the CPU 14—and ends the change determination process for the required value. As described above, when the state of the battery is not a state of discharge and the vehicle is not running, it is determined that the parameter settings of the in-vehicle system 10 are to be changed, so that the parameter settings of the in-vehicle system 10 can be safely changed.

On the other hand, when the state of the battery is a state of discharge—that is, when the determination in step 120 is affirmative—there are states such as parking (that is, ignition power off), stopping (that is, idling), and running at low speed due to traffic congestion. While these states are traveling states that are relatively safe for changing the parameter settings of the vehicle-mounted system 10, the situation is that the remaining battery level is decreasing. Therefore, the following determination is made from the viewpoint of preventing the battery from running down.

If the result of the determination in step 120 is affirmative, the process proceeds to step 124. In step 124, the controller 18 determines whether the power consumption of the in-vehicle system 10 is predicted to decrease with a change in the parameter settings of the in-vehicle system 10. Step 124 is an example of a third determination. If the determination in step 124 is affirmative, the process proceeds to step 130, and implementation of the parameter setting changes of the vehicle-mounted system 10 is output.

As described above, when the state of the battery is one of discharge and the power consumption of the in-vehicle system 10 is predicted to decrease with the changes in the parameter settings of the in-vehicle system 10, it is determined that the parameter settings of the in-vehicle system 10 are to be changed. Therefore, the amount of discharge of the battery can be suppressed.

On the other hand, if the determination in step 124 is negative—that is, if the controller 18 predicts that the power consumption of the in-vehicle system 10 will not decrease due to the changes in the parameter settings of the in-vehicle system 10—the process proceeds to step 126. In step 126, the controller 18 determines whether or not the remaining amount of the battery is equal to or greater than a threshold value. Step 126 is an example of a fourth determination. If the determination in step 126 is negative, the process proceeds to step 128, and maintenance of the parameter settings of the vehicle-mounted system 10 is output.

As described above, when the state of the battery is one of discharge, it is predicted that the power consumption of the vehicle equipment will not decrease in accordance with the setting changes of the parameters of the in-vehicle system 10, and the remaining amount of the battery is not equal to or greater than a threshold value, it is determined that the parameter settings are not to be changed. Thus, it is possible to avoid an increase in the amount of battery discharge.

If the determination in step 126 is affirmative, the process proceeds to step 130, and implementation of the parameter setting changes of the vehicle-mounted system 10 is output. As described above, when the state of the battery is one of discharge, it is predicted that the power consumption of the in-vehicle system 10 will not decrease in accordance with the setting changes of the parameters of the in-vehicle system 10, and the remaining amount of the battery is equal to or greater than a threshold value, it is determined that the parameter settings are to be changed. Thereby, the parameter settings of the in-vehicle system 10 can be changed while permitting the battery discharge amount to increase.

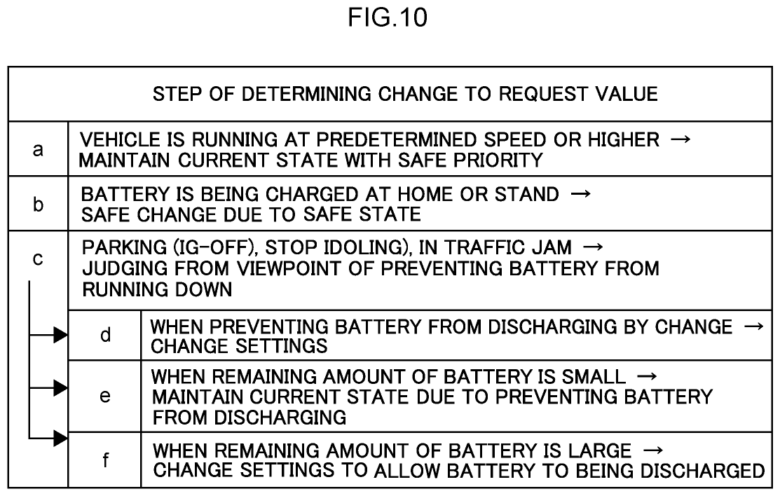

As described above, the change determination process for the request value shown in FIG. 9 is performed in consideration of safety when changing the settings of the parameters of the vehicle-mounted system 10, and setting changes to the parameters of the in-vehicle system 10 are performed only, for example, when the vehicle is stopped or when the battery level is low and it is unavoidable. The operation and effect of each route of the conditional branches of the change determination process for the request value shown in FIG. 9 are summarized as shown in FIG. 10. The symbols a to f shown in FIG. 10 correspond to the symbols a to fin FIG. 9.

Note that if a vehicle state transition occurs due to switching from manual driving to automatic driving or switching on a new service, there are no problems for a while. That is, even if it is determined that the settings of the parameters of the in-vehicle system 10 are to be maintained, by the change determination process for the required value illustrated in FIG. 9, there are no problems for a while.

In other words, services such as file downloading and video/audio streaming distribution are created on the premise of a best-effort communication environment. Best-effort communication is communication in which the communication speed, communication delays, and jitters are not constant and can be increased or decreased. For example, in file downloading, when the communication speed is low, the communication takes longer, but after this, when the communication speed increases, the delay can be recovered. Also, for example, in the streaming distribution of video and audio, when the communication speed and the arithmetic processing capability are low, the streaming distribution is performed with the image quality and sound quality lowered. However, thereafter, it is possible to switch to higher image quality and higher sound quality when the communication speed and the arithmetic processing capability have recovered.

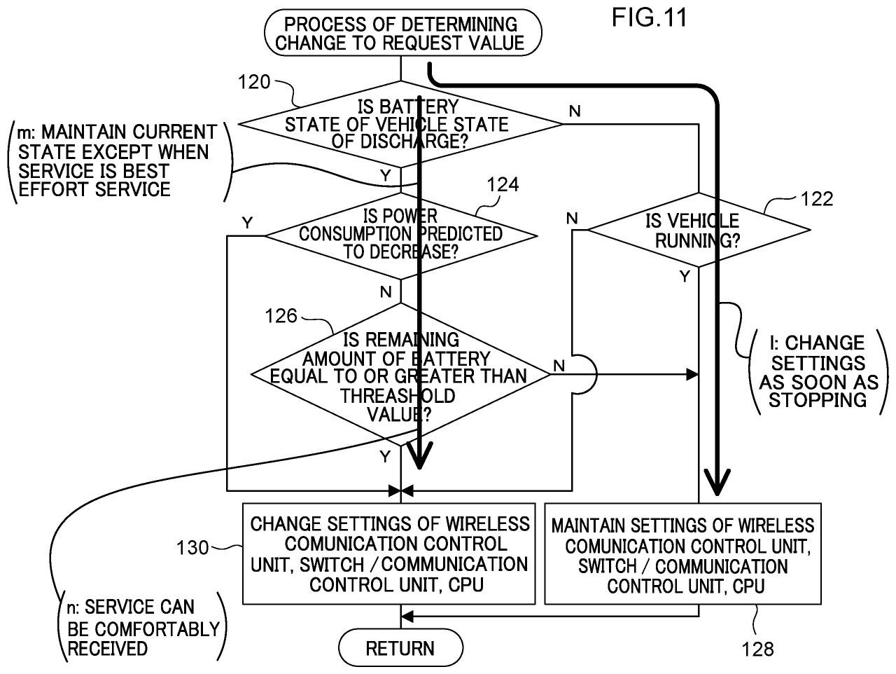

As an example, FIG. 11 shows a flow of processing when a new service is turned on while the vehicle is traveling, in the change determination processing of the request value shown in FIG. 9. Since the vehicle is running immediately after the vehicle state has changed, the parameter settings of the in-vehicle system 10 are not changed, as indicated by the symbol 1 in FIG. 11. However, if the turned on service is a best effort service, it is possible to start providing the service from this point. Thereafter, when the vehicle stops, the parameter settings of the on-vehicle system 10 are changed according to the turned on service, as indicated by the symbol m in FIG. 11. As a result, as shown by the symbol n in FIG. 11, the turned on service can be comfortably received.

As described above, in the present embodiment, when it is determined that the state of the vehicle, equipped with the in-vehicle system 10 having functions including providing services to the user transitions, the communication amount and the computation amount required for the on-board system 10 after the vehicle has transitioned, are acquired. Based on at least the state of the battery of the vehicle, it is determined whether or not to change the parameter settings of the in-vehicle system 10 so that the acquired communication amount and calculation amount are realized. As a result, it is possible to extend the service providing time by the vehicle-mounted system 10.

Further, in the present embodiment, when at least one of the running state of the vehicle and the service to be provided has changed, it is determined that the state of the vehicle transitions. Therefore, the occurrence of an event leading to a change in the amount of discharge of the battery can be determined as a transition in the state of the vehicle.

In the present embodiment, the traveling state information 34 that defines at least one of the communication amount and the calculation amount for each traveling state of the vehicle, and the operation service information 36 that defines at least one of the communication amount and the computation amount for each service to be provided, are stored. The required communication amount and calculation amount are obtained by multiplying the traveling state information 34 corresponding to the traveling state after the vehicle state transition and the operation service information 36 corresponding to the service provided after the vehicle state transition. Thereby, the acquisition of the communication amount and the operation amount required for the in-vehicle system 10 after the vehicle state transitions can be realized by a simple process of multiplying the traveling state information 34 and the operation service information 36.

Further, in the present embodiment, based on the state of the battery of the vehicle, the running state of the vehicle, and whether or not the power consumption of the in-vehicle system 10 is predicted to decrease in accordance with the setting changes of the parameters of the in-vehicle system 10, it is determined whether or not the parameter settings of the in-vehicle system 10 are to be changed. This makes it possible to determine whether or not to change the parameter settings of the in-vehicle system 10 more appropriately in consideration of safety and trends in changes in the remaining battery level caused by changing the parameter settings of the in-vehicle system 10.

### Second Exemplary Embodiment

Explanation follows regarding a second exemplary embodiment of the present disclosure. Since the second embodiment has the same configuration as the first embodiment, the same reference numerals are given to the respective portions, and the description of the configuration is omitted, and the operation of the second embodiment will be described below.

FIG. 9 shows a process of determining a change to a request value described in the first embodiment. When the state of the battery is one of discharge—that is, when the determination in step 120 is affirmative and the power consumption of the in-vehicle system 10 is predicted to decrease with a change in the parameter settings of the in-vehicle system 10—that is, when the determination in step 124 is affirmative—it is determined that the parameter settings of the in-vehicle system 10 are to be changed as in step 130. An example of a situation corresponding to this is a situation in which a parameter setting of the in-vehicle system 10 is changed while the vehicle is traveling at low speed due to traffic congestion or is stopped at a traffic light.

However, even when the vehicle is traveling at low speed due to traffic congestion or while the vehicle is stopped due to waiting for a traffic light, there may be a case where it is not desired to change the settings of the parameters of the vehicle-mounted system 10. Specifically, when it is not guaranteed that the parameter setting change of the in-vehicle system 10 is completed in a short time lasting seconds, there is a possibility that a situation will arrive in which the vehicle must start moving even in a state in which the parameter setting change of the in-vehicle system 10 is not completed; that is, a state in which the environment in which the service is normally provided is not established.

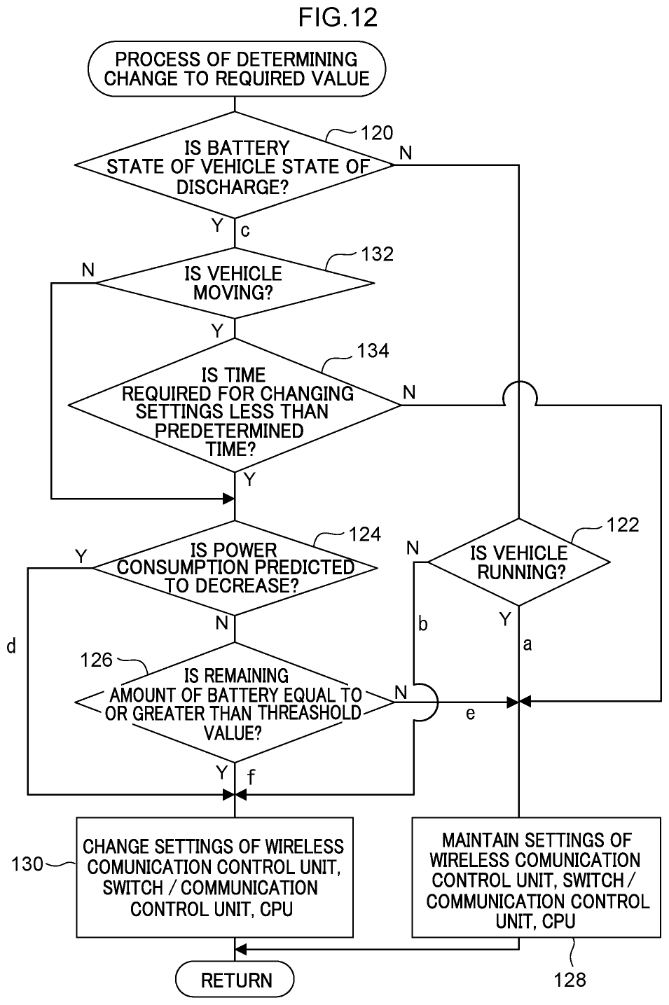

In consideration of the above, in the second embodiment, the processing shown in FIG. 12 is performed as the change determination processing for the request value. In the process of determining the change to the required value according to the second embodiment, the process proceeds to step 132 when the determination in step 120 is affirmative.

In step 132, the controller 18 determines whether the vehicle is moving. Step 132 is an example of a fifth determination. This determination can be realized, for example, by utilizing an image captured by an in-vehicle camera and determining from the image whether the vehicle is on a road. For example, if it can be determined that the vehicle is not on the road, such as being in a parking lot, it is determined that the vehicle is not moving, such as not running at low speed due to traffic congestion, or not stopping due to a traffic light, and the determination in step 132 is negative and the process proceeds to step 124. Then, the processing from step 124 onward is performed.

On the other hand, when the vehicle is on the road, it can be determined that there is a high possibility that the vehicle must start moving according to the road conditions. Therefore, when the vehicle is on the road, the determination in step 132 is affirmative, and the process proceeds to step 134. In step 134, the controller 18 determines whether or not the time required for changing the parameter settings of the in-vehicle system 10 is less than a predetermined time. Step 134 is an example of a sixth determination.

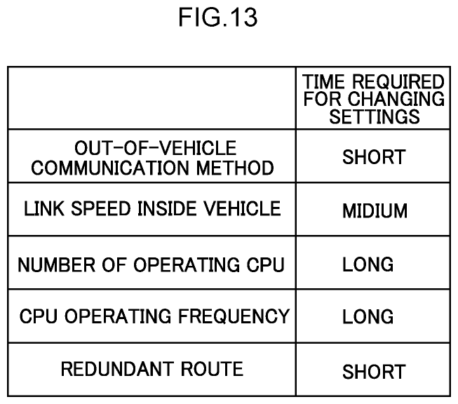

The time required to change the parameter settings of the in-vehicle system 10 depends on the parameter items to be changed; that is, the “external communication method”, “in-vehicle link speed”, “number of operating CPUs”, “CPU operating frequency”, and “redundant path”. As shown in an example in FIG. 13, when only the “out-of-vehicle communication method” is changed, there is no direct effect on the running of the vehicle, so that the time required for the setting change can be determined to be “short”. On the other hand, when changing the “number of operating CPUs” or the “CPU operating frequency”, not only communication but also software operation needs to be temporarily stopped and restarted. Therefore, the time required for the setting change can be determined to be “long”. The determination in step 134 can be made using a table as shown in FIG. 13.

If the time required to change the parameter settings of the in-vehicle system 10 is equal to or longer than the predetermined time, the determination in step 134 is negative, and the process proceeds to step 128 to output maintenance of the parameter settings of the in-vehicle system 10. As a result, for example, when it becomes necessary to start moving the vehicle, it is possible to avoid a state in which the setting change of the parameters of the in-vehicle system is not completed; that is, a state in which the environment in which the service is normally provided is not established. If the time required to change the parameter settings of the in-vehicle system 10 is less than the predetermined time, the determination in step 134 is affirmative, and the process proceeds to step 124 to perform the processing of step 124 and subsequent steps.

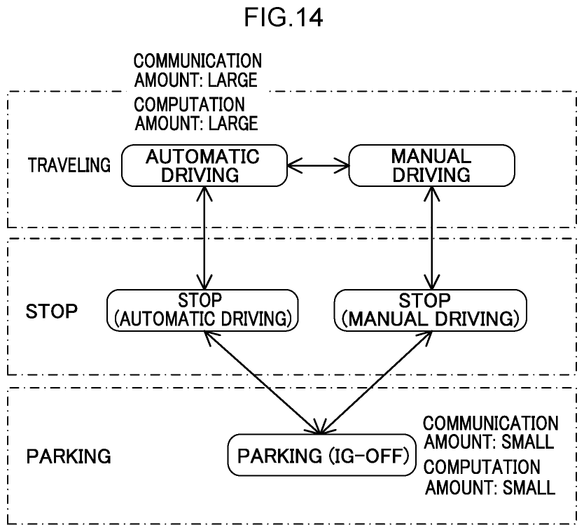

FIG. 3 shows an example in which the “running state” is divided into four states, and the stopped state during automatic driving and the stopped state during manual driving are shared by “stopped (idling)”. However, the method of dividing the “running state” is not limited to the example shown in FIG. 3. For example, even in the “stopped” state such as idling or the like, it is assumed that the amount of communication and the amount of computation are larger during automatic driving than during manual driving. Therefore, as shown in FIG. 14 as an example, the “running state” may be divided into five states.

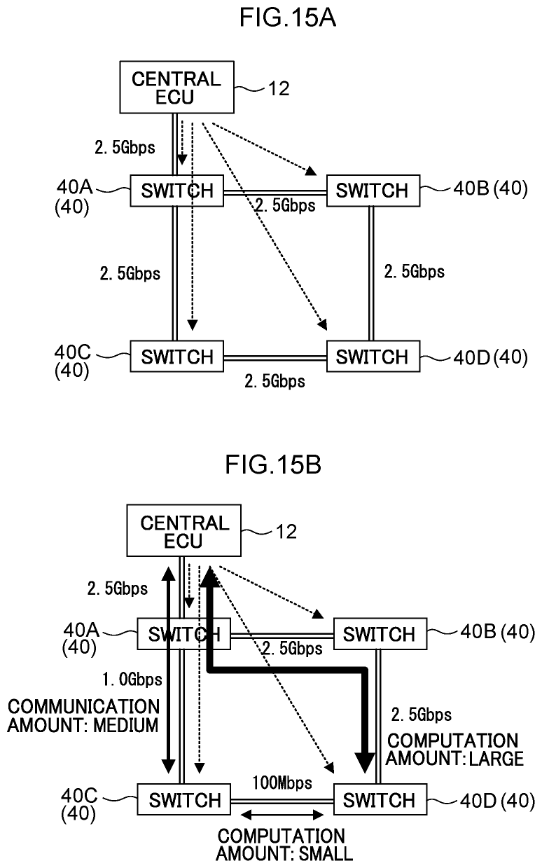

In the above description, an aspect has been explained in which each communication link connecting the central ECU 12 and the switches 40A to 40D—that is, the “in-vehicle link speed” in the Ethernet communication line 44—is set to a uniform link speed in the vehicle-mounted system 10. See also FIG. 7. For example, in the calculation of the required value in step 102 in FIG. 2, when 2.5 Gbps is calculated as the “in-vehicle link speed”, as shown in FIG. 15A as an example, the “in-vehicle link speed” for each communication link is uniformly set to 2.5 Gbps. However, it is not limited to this.

For example, the amount of data transmitted and received by the central ECU 12 and the ECUs 42A to 42D connected to the switches 40A to 40D is generally not uniform, and the amount of data flowing through each communication link is often not uniform. Here, if the transmission/reception data amount in the in-vehicle system 10 can be individually estimated for each communication link, as shown in FIG. 15B as an example, the “in-vehicle link speed” may be set to a different value for each communication link. As described above, instead of adjusting the “in-vehicle link speed” of each communication link all to the link speed of the communication link having the maximum amount of transmitted/received data, the “in-vehicle link speed” of the communication links having relatively small amounts of transmitted/received data are used individually, whereby further power saving can be realized.

Further, in the above, an aspect has been explained in which, when it is determined that the state of the vehicle transitions, the communication amount and the computation amount required for the in-vehicle system 10 after the state transition of the vehicle are each acquired, and at least based on the state of the battery of the vehicle, it is determined whether to change the parameter settings of the in-vehicle system 10 so that the acquired communication amount and the operation amount are each realized. However, the present invention is not limited to this, and either one of the communication amount and the calculation amount may be set as the processing target.

Further, the processing performed by the controller 18 in each of the above-described embodiments has been described as software processing performed by executing a program, but it is not limited thereto. For example, the processing may be performed by hardware. Alternatively, the processing may be a combination of both software and hardware. In the case of software processing, the program may be stored in various non-transitory storage media such as a DVD (Digital Versatile Disc), distributed, and executed by a processor such as the CPU of the controller 18.

What is claimed is:

1. A vehicle equipment control device, comprising:
a memory; and
a processor, the processor being configured to:
determine whether a state of a vehicle will transition to another state, the vehicle being equipped with a vehicle equipment having a function including providing a service to a user,
in a case in which the state of the vehicle will transition, acquire at least one of a communication amount or a calculation amount which will be required by the vehicle equipment after the state of the vehicle has transitioned to another state; and
based at least partially on a battery state of the vehicle, determine whether or not to change a parameter of the vehicle equipment so as to realize at least one of the acquired communication amount or the acquired calculation amount.

2. The vehicle equipment control device of claim 1, wherein the processor is configured to determine that the state of the vehicle will transition to another state in a case in which at least one of a traveling state of the vehicle or a service provided by the vehicle equipment has changed.

3. The vehicle equipment control device of claim 1, wherein:
the memory is configured to store first information that defines at least one of a communication amount or a calculation amount for each respective traveling state of the vehicle, and second information that defines at least one of a communication amount or a calculation amount for each respective service provided by the vehicle equipment; and
the processor is configured to acquire at least one of the required communication amount or the required calculation amount by multiplying first information that corresponds to a traveling state after transition of the state of the vehicle, and second information that corresponds to a service provided after transition of the state of the vehicle.

4. The vehicle equipment control device of claim 1, wherein the processor is configured to determine whether or not to change the parameter of the vehicle equipment based on the battery state of the vehicle, a traveling state of the vehicle, and whether or not it is predicted that power consumption of the vehicle equipment will decrease due to changing the parameter of the vehicle equipment.

5. The vehicle equipment control device of claim 1, wherein the processor is configured to determine not to change the parameter of the vehicle equipment in a case in which a first determination, as to whether or not the battery state is a state of discharge, is negative, and a second determination, as to whether or not the vehicle is traveling, is affirmative.

6. The vehicle equipment control device of claim 1, wherein the processor is configured to change the parameter of the vehicle equipment in a case in which a first determination, as to whether or not the battery state is a state of discharge, is negative, and a second determination, as to whether or not the vehicle is traveling, is negative.

7. The vehicle equipment control device of claim 1, wherein the processor is configured to change the parameter of the vehicle equipment in a case in which a first determination, as to whether or not the battery state is a state of discharge, is affirmative, and a third determination, as to whether or not it is predicted that power consumption of the vehicle equipment will decrease due to changing the parameter of the vehicle equipment, is affirmative.

8. The vehicle equipment control device of claim 1, wherein the processor is configured to determine not to change the parameter of the vehicle equipment in a case in which a first determination, as to whether or not the battery state is a state of discharge, is affirmative, a third determination, as to whether or not it is predicted that power consumption of the vehicle equipment will decrease due to changing the parameter of the vehicle equipment, is negative, and a fourth determination, as to whether or not a remaining amount of the battery is equal to or higher than a predetermined value, is negative.

9. The vehicle equipment control device of claim 1, wherein the processor is configured to change the parameter of the vehicle equipment in a case in which a first determination, as to whether or not the battery state is a state of discharge, is affirmative, a third determination, as to whether or not it is predicted that power consumption of the vehicle equipment will decrease due to changing the parameter of the vehicle equipment, is negative, and a fourth determination, as to whether or not a remaining amount of the battery is equal to or higher than a predetermined value, is affirmative.

10. The vehicle equipment control device of claim 5, wherein the processor is configured to determine not to change the parameter of the vehicle equipment in a case in which the first determination is affirmative, a fifth determination, as to whether or not the vehicle is moving, is affirmative, and a sixth determination, as to whether or not a time required for the change to the parameter of the vehicle equipment is less than a predetermined time, is negative.

11. A method of controlling vehicle equipment, the method comprising, by a processor:
determining whether a state of a vehicle will transition to another state, the vehicle being equipped with the vehicle equipment, which has a function including providing a service to a user,
in a case in which the state of the vehicle will transition, acquiring at least one of a communication amount or a calculation amount which will be required by the vehicle equipment after the state of the vehicle has transitioned to another state; and
based at least partially on a battery state of the vehicle, determining whether or not to change a parameter of the vehicle equipment so as to realize at least one of the acquired communication amount or the acquired calculation amount.

12. The method of controlling vehicle equipment of claim 11, the method further comprising, by the processor, determining that the state of the vehicle will transition to another state, in a case in which at least one of a traveling state of the vehicle or a service provided by the vehicle equipment has changed.

13. The method of controlling vehicle equipment of claim 11, the method further comprising:
at a memory, storing first information that defines at least one of a communication amount or a calculation amount for each respective traveling state of the vehicle, and second information that defines at least one of a communication amount or a calculation amount for each respective service provided by the vehicle equipment; and
by the processor, acquiring at least one of the required communication amount or the required calculation amount by multiplying first information that corresponds to a traveling state after transition of the state of the vehicle, and second information that corresponds to a service provided after transition of the state of the vehicle.

14. A non-transitory storage medium storing a program executable by a processor to perform vehicle equipment control processing comprising:
determining whether a state of a vehicle will transition to another state, the vehicle being equipped with an vehicle equipment having a function including providing a service to a user,
in a case in which the state of the vehicle will transition, acquiring at least one of a communication amount or a calculation amount which will be required by the vehicle equipment after the state of the vehicle has transitioned to another state; and
based at least partially on a battery state of the vehicle, determining whether or not to change a parameter of the vehicle equipment so as to realize at least one of the acquired communication amount or the acquired calculation amount.

15. The non-transitory storage medium of claim 14, the vehicle equipment control processing further comprising determining that the state of the vehicle will transition to another state in a case in which at least one of a traveling state of the vehicle or a service provided by the vehicle equipment has changed.

16. The non-transitory storage medium of claim 14, the vehicle equipment control processing further comprising:
at a memory, storing first information that defines at least one of a communication amount or a calculation amount for each respective traveling state of the vehicle, and second information that defines at least one of a communication amount or a calculation amount for each respective service provided by the vehicle equipment; and
acquiring at least one of the required communication amount or the required calculation amount by multiplying first information that corresponds to a traveling state after transition of the state of the vehicle, and second information that corresponds to a service provided after transition of the state of the vehicle.
